(19) United States
(12) Patent Application Publication
(10) Pub. No.: US 2004/0059505 A1
(43) Pub. Date: Mar. 25, 2004

(54) Method for monitoring depositions onto the interior surface within a pipeline

(75) Inventor: Christopher T. Gallagher, Katy, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes Incorporated, Houston, TX

(21) Appl. No.: 10/622,308

(22) Filed: Jul. 18, 2003

Related U.S. Application Data
(60) Provisional application No. 60/400,378, filed on Aug. 1, 2002.

(51) Int. Cl. G06F 19/00

(52) U.S. Cl. 702/1

(57) ABSTRACT

Disclosed is a method and system for monitoring the accumulations of materials with the interior of a pipeline. The method of the present invention includes use of an array of temperature sensors along the outside of a pipeline, measuring the rate at which heat passing through the wall of the pipeline varies with time. Areas of lower heat loss rates are areas where materials have either been deposited upon the wall of the pipeline or are areas where a denser phase of material has been held up in the pipeline. Based upon the difference in rates of heat transfer, models can be prepared which allow for the distinguishing between the compositions of the accumulated materials.

### CROSS REFERENCE TO RELATED APPLICATION

This application claims priority from U.S. Provisional Patent Application Ser. No. 60/400,378 filed on Aug. 1, 2002.

### BACKGROUND OF THE INVENTION

1. Field of the Invention

This invention relates to the maintenance of pipelines and more particularly to the maintenance of undersea pipelines.

2. Background of the Art

Pipelines are widely used in a variety of industries, allowing a large amount of material to be transported from one place to another. A variety of fluids, such as oil and/or gas, as well as particulate, and other small solids suspended in fluids, are transported cheaply and efficiently using underground pipelines. Pipelines can be subterranean, submarine, on the surface of the earth, and even suspended above the earth. Submarine pipelines especially carry enormous quantities of oil and gas products indispensable to energy-related industries, often under tremendous pressure and at low temperatures and at high flow rates.

Unfortunately, undersea pipelines, particularly those pipelines running from undersea production wells to loading facilities, commonly referred to as flowlines, are subject to fouling. Materials being transported through the pipelines can leave deposits upon the interior surfaces of the pipeline which can, over time, reduce the flow through the pipeline. For example, pipelines which carry production fluids from oil and gas wells can accumulate, as deposits, organic materials such as paraffins and asphaltenes, inorganic materials such as scale, and even complex materials such as methane water adducts, commonly referred to as hydrates. All of these materials can cause loss of throughput through a flowline, which is usually undesirable.

Consequently, industry has produced various devices for detecting and removing such materials. For example, it is known to use a pipeline inspection apparatus that includes a vehicle capable of moving along the interior of the pipe by the flow of fluid through the pipe to inspect the pipe for location of anomalies. Such prior art inspection vehicles, commonly referred to as “pigs,” have typically included various means of urging the pigs along the interior of the pipe including rubber seals, tractor treads, and even spring-loaded wheels. In the case of the latter, the pigs have further included odometers that count the number of rotations of the wheels. Various measurements have been made with pigs using wipers or even the wheels of pigs having wheels. The wipers or wheels of pigs have included devices such as ultrasound receivers, odometers, calipers, and other electrical devices for making measurements. After deposits have been detected, another version of pigs can be used to remove the deposits from the wall of the pipelines.

The use of pigs, while well known and generally dependable, is not without its problems. For example, a pig, depending upon its purpose, can significantly reduce the flow of materials through a pipeline while the pig is present therein. Even more undesirable is the possibility that a pipeline has become so narrowed or blocked that a pig can be lost within a pipeline and require a reverse flush of the pipeline, or even more drastic measures, to retrieve it. In some applications, a pipeline must be shutdown completely during pigging operations. Most pipelines are privately operated and any loss in production, including loss of production due to downtime for pigging operations, can be costly.

It would be desirable in the art of operating pipelines to be able to monitor the pipeline for accumulation of materials on the inner surface of the pipeline without resort to use of pigs or other intrusive devices. It would also be desirable in the art of operating pipelines to be able to determine the type of accumulation and location of accumulation of materials on the inner surface of a pipeline without resort to the use of pigs or other intrusive devices.

### SUMMARY OF THE INVENTION

In one aspect, the present invention is a method for monitoring a pipeline for accumulation of materials within the interior of the pipeline, if any, comprising: a) making a first temperature measurement of the outside surface of the pipeline at a first point downstream from the influent; b) making a second temperature measurement of the outside surface of the pipeline at a second point downstream from the first point; and c) using the temperature measurements to determine: (i) the location of material forming the accumulation within the pipeline, if any; (ii) the amount of material forming the accumulation within the pipeline, if any; (iii) composition of material forming the accumulation within the pipeline, if any; or (iv) any combination of two or more of (i), (ii), (iii).

In another aspect, the present invention is a pipeline monitoring system, for performing the method of the present invention, including a pipeline, an internal temperature sensor, a first external sensor array, and a computer capable of accessing the data from the internal temperature sensor and first external sensor array.

Examples of the more important features of the invention have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, reference should be made to the following detailed description of the preferred embodiment, taken in conjunction with the accompanying drawings, in which like elements have been given like numerals, wherein:

FIG. 1 is a schematic illustration of a subsea oil and gas production, collection, and shipping facility including a pipeline including the elements of the present invention.

FIG. 2 is a schematic illustration of a cross section of the pipeline of FIG. 1.

### DETAILED DESCRIPTION OF THE PREFERRED EMBODIMENT

In one embodiment, the present invention is a method for monitoring a pipeline for accumulation of materials upon the inner surfaces of the pipeline. In a preferred embodiment, the pipeline is a flowline that is an element of a subsea oil and gas production, collection, and shipping facility, including an offloading system, such as a buoy or platform offloading system. Product leads normally extend from the subsea wells to a manifold from which flow lines bring the production fluid to a buoy or platform for transport. Such product flowlines have been metal pipes, sometimes with intermediate floatation devices located along the lengths of the product flowlines, to provide a suitable contour or configuration to the flowlines to avoid excessive loads resulting from the weight of the flowlines.

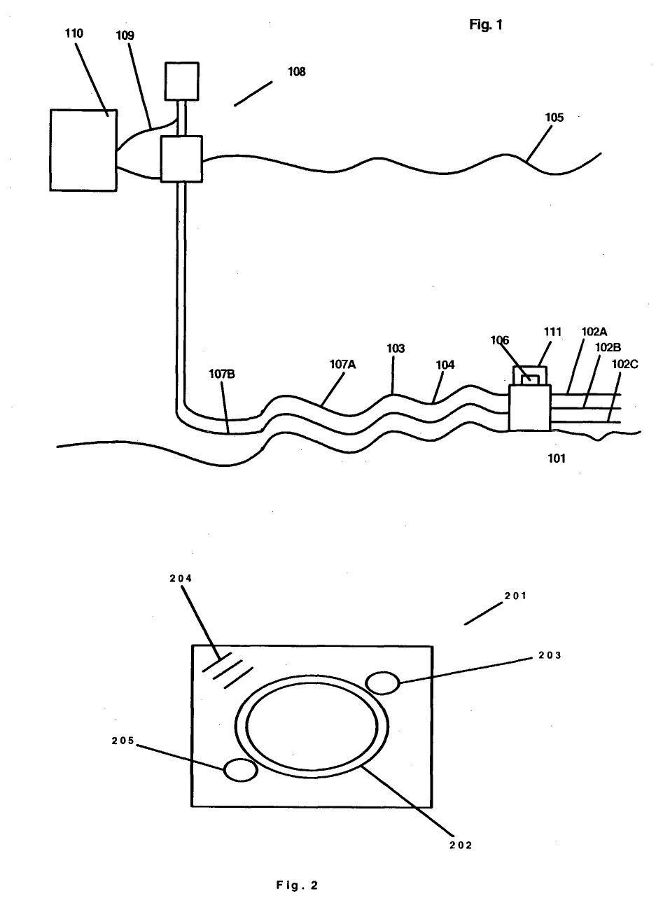

While the method of the present invention can be used with any pipeline, it is particularly useful with a subsea pipeline where the great depth of the pipeline can make the pipeline even more inaccessible than subterranean pipelines. FIG. 1 shows such a pipeline. The method of the present invention is particularly useful for monitoring such a pipeline for accumulation within the pipeline of materials selected from the group consisting of paraffins, asphaltenes, scale, water, hydrates, and mixtures thereof.

In FIG. 1, several leads 102A-C from several production wells (not shown) terminate at a manifold 106 from which extend two flow lines 107A and 107B. The flow lines run along the ocean floor 101. The ocean floor 101 is contoured resulting in both high points (or hills) 103 and low points (or valleys) 104 within the flowlines 107A and 107B. The two flowlines, 107A and 107B, extend to a offloading system 108 which includes a loading line 109 and a barge or other floating vessel 110. Also shown on the manifold is a loop 111, useful in pigging operations.

In FIG. 2, a cross section of the pipeline 102 is shown. The pipeline includes a bundle, 201 which in turn includes the pipe 202, a temperature sensor 203, and optional insulation 204. In addition the bundle can also include a heater 205.

In the practice of the present invention, preferably a sensor array is used along the entire length of the pipeline 102, including the flowlines 107A and 107B. While any means of making temperature measurements can be used as the sensors 203 for the present invention, preferably the sensors are part of a fiber optic distributed sensor array. Such fiber optic distributed sensor arrays are known in the prior art and are disclosed in, for example, U.S. Pat. No. 6,271,766 and 5,113,277.

Preferably the sensor array consists of a fiber optic cable and temperatures sensors distributed along the cable. Preferably the sensors are less than about 100 meters apart. More preferably the sensors are less than about 10 meters apart. Even more preferably, the sensors are about 1 meter apart.

In addition to the elements shown in the drawings, the system of the present invention includes all of the hardware, including a computer, and software necessary to practice the method of the present invention. For example, in one embodiment, a fiber optic distributed temperature sensor system outputs a temperature distribution along the longitudinal direction of a sensor optical fiber by measuring the temperature dependency of Raman scattered light intensity. Such a system is characterized in that a light output from a light source is input to the sensor (optical fiber) via an optical wavelength division demultiplexer, that among the reflected light of back scattered light returning from the sensor optical fiber, light of a particular wavelength range is reflected or transmitted by at least one optical filter of the optical wavelength division demultiplexer to separate the light of the particular wavelength range and that signal of the light of the particular wavelength range is guided to a detector of an optical measuring system.

The distributed sensor array can also include one or more light sources, amplifiers, switching devices, and filters. The array can include one or more interfaces to at least one computer. The computer can include a memory, a information storage device, at least one output device, a communications interface, and any other hardware or software necessary to the practice of the method of the present invention.

In the method of the present invention, at least two measurements of the temperature of the pipe in the pipeline are made. Preferably a great many more measurements are made. In one preferred embodiment a measure is made at one-meter increments along the entire length of the pipeline. Using the computer, the measurements are used to prepare a temperature profile, preferably in real time, of the outer surface of the section of pipeline being monitored by the method of the present invention.

In the method of the present invention, the temperature of the influent of the pipeline is measured, preferably at a point at or just upstream from the section of the pipeline to be monitored. Preferably, additional measurements of the temperature of the influent are also made. Such measurements can be made using any method of measuring the temperature of a fluid passing through a pipe known to those of ordinary skill in the art.

The influent can be a single phase, a two phase or even a three phase admixture. Production fluid can have up to three phases of non-solid materials: hydrocarbons, aqueous solutions, and gas. The production fluid can include solids, some actually exiting the well as solids and other solids precipitating due to changes in temperature, pressure or production fluid composition.

As it is produced, production fluids are often very warm. However, as they are transported along a pipeline that is at a very low depth, the fluids can become very cold. In the method of the present invention, it is the rate of transfer of heat between the interior and exterior of the pipeline that is used to determine the location and type of deposit, if any, on the interior of a pipeline.

In the practice of the method of the present invention, for any given pipeline, preferably a history of the pipeline is used to generate a model for detecting deposits on the interior surface of the pipeline. In this model, the rate of heat transfer across the pipe is measured along the length of interest of the pipeline. A decrease in the rate of transfer is indicative of a deposit. In one embodiment, a second temperature sensor array is run so that one array is along the top of the pipeline and the second is along the bottom. A difference in the rate of heat transfer between the upper and lower array could indicated a section of the pipeline wherein heavy solids were sitting on the bottom of the pipeline rather than being deposited around the circumference of the pipeline or the more likely occurrence of a “holding up” of a denser phase of material, usually water where the continuous phase is primarily gas and hydrocarbons.

Using the two array embodiment of the present invention, a build up of a hydrate deposit could be detected wherein there deposit was along the bottom, but not the top of the pipeline. This could be due to a situation wherein the water was held up in, for example the valley 104 of a flowline, and began to interact with methane to form hydrates. The hydrates could act as an insulator. The areas of water holdup could themselves be detected as a “puddle” of water in the valley of the pipeline, which would transfer heat at a different rate than a substantially non-aqueous fluid moving past the puddle. Both of these situations could be detected using the dual sensor array embodiment of the present invention.

Hydrates are a particular problem with undersea pipelines that are very deep. Hydrates are adducts of water and methane and/or other hydrate formers which can form when water comes into contact with methane at low temperatures and pressures sufficient to allow for the hydrogen bonding between the oxygen in water and the methyl hydrogens. Undersea pipelines often follow the contours of the ocean bottoms. When sufficient water is held up in a pipeline as a separate phase and methane is, in effect, passed through the water phase, hydrates are particularly likely to form. The method of the present invention is particularly useful for detecting and then treating the both the holding up of water as a separate phase in the pipeline and the formation of hydrates in a pipeline.

The rate at which deposits accumulate could also be used to qualitatively identify deposits. Based on the temperature of the fluid in the pipeline and the characteristics of the production fluid, it could be determined whether a material depositing on the pipe was either paraffins or asphaltenes, for example.

Other variables can also be used to model amount and type of deposits. For example, if a pressure drop was also measured for a given section of pipeline, the thickness of the deposit could be estimated. If the thickness of the deposit is known, and the rate of heat flow through the deposit measured, then it could be determined which of the possible materials was causing the deposits as each possible material could have a different insulative property. For example, paraffins could be a better insulator than asphaltenes and thus the two materials would be distinguishable. In systems where the temperature of the influent varies, it could be desirable to measure the temperature of the influent and use variations therein in interpreting changes in the rate of heat passing through the walls of a pipeline. This measurement could be used in preparing the models of the present invention.

Once the material causing the deposit is determined, the method of the present invention also includes performing an operation to reduce or eliminate the deposit. For example, a pigging operation could be performed on the flowlines (107A and 107B) in FIG. 1. In this operation, a pig can be introduced into a first flowline 107A, and then recovered through 107B, the operation being repeated until the deposits were reduced to a level acceptable to continued operation of the pipeline.

In another example, if it were determined that there was an asphaltene deposit in the pipeline, then a chemical agent useful for reduce asphaltene deposits could be used. The effect of chemical agents on deposits could also be used to prepare a predictive model for qualitative determinations of deposits. The additives could be added in any way and at any location known to be useful to those of ordinary skill in the art of maintaining pipelines to be useful.

While chemical treatment and pigging are procedures useful with the method of the present invention, any method known to be useful for reducing deposits within a pipeline known to those of ordinary skill in the art of maintaining pipelines can be used with the method of the present invention.

In addition to being a stand-alone system, the system of the present invention can be used in conjunctions with other systems to maintain a pipeline. For example, the method of the present invention could include communicating deposit information to an automatic treatment system, such as the SENTRY™ system, available from Baker Petrolite. In this embodiment, the production fluid could be treated automatically at some preset level of deposition within the pipeline to reduce the level of the deposits. The advantage of this embodiment of the present invention is that deposits can be eliminated quickly without requiring operator intervention. Another advantage is chemical treatment offers the economic incentive of no downtime.

In the practice of the method of the present invention, it is preferred to affix or otherwise put into contact a sensor array with a pipeline at the exterior surface of the pipe. In an alternative embodiment, the array can be inset into the wall of the pipe and such an embodiment is within the scope of the present invention. Also an embodiment of the present invention is an application where the sensor array is placed into contact with a temperature conducting substrate that is in contact with the pipe of a pipeline. While within the scope of the claims of the present invention, placing the sensor array into contact with an insulative material on the surface of the pipe is not a preferred embodiment unless there is a substantial temperature differential between the interior and exterior of the pipe and the insulative material allows for enhanced measurements of the rate of heat flow through the wall of the pipeline.

While the practice of the present invention is particularly suitable for undersea pipelines, it can also be used with any pipeline. The present invention is particularly suitable for use with any pipeline carrying materials that can cause deposits to form within and having a temperature gradient between the material being transported and the exterior of the pipeline.

The present invention is particularly useful with pipelines transporting production fluid produced from oil and gas wells, particularly offshore produced oil and gas. While particularly useful for oil and gas productions, the method of the present invention can also be used with any pipeline carrying a fluid (either liquid or gas) that causes deposits within the pipeline. For example, any pipeline carrying a fluid that includes dissolved solids capable of precipitating to form deposits could be monitored using the method of the present invention. In another example, the production tubing in an oil well or even the wellbore itself could be the pipeline of the present invention.

While the foregoing disclosure is directed to the preferred embodiments of the invention, various modifications will be apparent to those skilled in the art. It is intended that all variations within the scope of the appended claims be embraced by the foregoing disclosure.

What is claimed is:

1. A method for monitoring a pipeline for accumulation of materials within the interior of the pipeline, if any, comprising:
a) making a first temperature measurement of the outside surface of the pipeline at a first point downstream from the influent;
b) making a second temperature measurement of the outside surface of the pipeline at a second point downstream from the first point; and
c) using the temperature measurements to determine:
(i) the location of material forming the accumulation within the pipeline, if any;
(ii) the amount of material forming the accumulation within the pipeline, if any;
(iii) composition of material forming the accumulation within the pipeline, if any; or
(iv) any combination of two or more of (i), (ii), (iii).

2. The method of claim 1 wherein the influent is a production fluid from an oil or gas well.

3. The method of claim 2 wherein the pipeline is an undersea pipeline.

4. The method of claim 3 wherein the materials accumulating within the pipeline, if any, are selected from the group consisting of paraffins, asphaltenes, scale, water, hydrates, and mixtures thereof.

5. The method of claim 1 wherein the pipeline is a flowline.

6. The method of claim 1 wherein the temperature measurements of the outside surface of the pipeline is made using an optical fiber distributed sensor array.

7. The method of claim 6 wherein a temperature measurement is made at an interval of from 1 to 1000 meters along the length of the pipeline.

8. The method of claim 7 wherein a temperature measurement is made at an interval of from 10 to 100 meters along the length of the pipeline.

9. The method of claim 7 wherein the temperature measurements are used to prepare a temperature profile.

10. The method of claim 9 wherein the temperature profile is prepared using a computer.

11. The method of claim 10 wherein the temperature profile is prepared in real time.

12. The method of claim 1 additionally comprising treating the pipeline to reduce the accumulation of material within the pipeline, if any.

13. The method of claim 1 wherein the accumulation of materials within the interior of the pipeline, if any, is in the form of a solid deposit on the interior surface of the pipeline.

14. The method of claim 1 wherein the accumulation of materials within the interior of the pipeline, if any, is in the form of a held up water phase.

15. The method of claim 14 wherein the held up water phase fills a section of the pipeline and the influent into the pipeline includes methane.

16. The method of claim 17 wherein the accumulation of materials within the interior of the pipeline, if any, is methane hydrate.

17. The method of claim 1 additionally comprising measuring the temperature of the influent into a pipeline.

18. A pipeline monitoring system for performing the method of claim 1 comprising a pipeline, an internal temperature sensor within the pipeline, a first external sensor array in contact with the exterior of the pipeline, and a computer capable of accessing the data from the internal temperature sensor and first external sensor array.

19. The system of claim 18 wherein the external sensor array is an optical fiber distributed sensor array.

20. The system of claim 19 additionally comprising a second external sensor array in contact with the exterior of the pipeline.

21. The system of claim 20 wherein the first external sensor array is along the bottom of the pipeline and the second external sensor array is along the top of the pipeline.

22. The system of claim 18 additionally comprising a system for treating the influent to the pipeline to reduce the accumulation of materials with the interior of the pipeline.

23. The system of claim 1 wherein the system for treating the influent to the pipeline is a SENTRY system.
